SEQUENCE LISTING (3 sequences)

SEQ ID NO: 1 - protein, 604 aa, Penicillium chrysogenum
  SIGNAL (1)..(18)
MKSTIITSILFSVAAVQAYSPAEQIDVQSHLLSDPTKVEGETYDYVIAGGGLTGLTVAAKLSENPKIKVLVIEKGFYESNDGPIIEDPNAYGEIFGTSVDQNYLTVPLINNRTGEIKSGLGLGGSTLINGDSWTRPDKVQIDSWEKVFGMEGWNWDNVFQYMQKAERSRPPTAAQIEAGHFYDPACHGTDGTVHAGPRDNGKPWSPLMRALMNTVSAFGVPVQKDFHCGHPRGVSMIPNNLHENQIRADAAREWLLPNYQRDNLQILTGQKVGKVLFNQTASGPKAVGVNFGTNKAVNFNVYAKQEVLLAAGSAISPLILEYSGIGIKSVLDKAGVKQLLELPVGLNMQDQTTTTVRSRANNAPGQGQAAYFANFTEVLGDHAAQGIKLLDTKLDQWAEETVARGGFHNVTALKIQYENYRNWLLDEDVAFAELFFDTEGKINFDIWNLIPFTRGSVHILSSDPYLWQYANDPKFFMNELDLLGQAAATKLGRELSSAGEMKKYYAGETIPGDNLPQDATVEQWEDYVMMNFRPNWHAVSTCSMMSRELGGVVDATAKVYGTQGLRVIDGSIPPTQVSSHVMTVFYGMALRIAESVLEDYAKKA

SEQ ID NO: 2 - DNA, 1816 bp, Penicillium chrysogenum
  source (1)..(1816): /organism=“penicillium chrysogenum” /mol_type=“unassigned DNA”
  SIGNAL (1)..(54)
  terminator (1813)..(1816)
atgaagtccactattatcacctccattctcttctctgtggctgccgtccaggcctatagcccggccgagcagatcgacgtccagtctcacctgctttctgaccccaccaaggtcgagggagagacttacgactatgtcattgctggtggtggtttgactggtctgaccgtggctgccaagctgtctgaaaacccgaagatcaaagtccttgtgattgagaagggattctacgaatccaacgatggaccgatcatcgaggaccccaacgcctatggggagatctttggaactagtgtggatcagaattatctcacagttcccctcatcaacaaccgaactggggaaattaagtctggcctcggtcttggtggctcgaccttgatcaacggcgattcctggacccgccccgacaaggtccagatcgactcatgggaaaaggtctttggcatggagggctggaactgggacaatgtcttccagtacatgcagaaagctgagcgctcgcgccccccgactgccgcccagattgaagccggtcacttctacgaccctgcctgtcatggaacagacggaaccgttcatgccggccctcgcgacaacggcaagccttggtccccactgatgcgagccctcatgaacaccgtctccgctttcggtgtccccgtccagaaggacttccactgcggtcacccccgtggtgtctcgatgatcccgaacaacctccatgagaaccagatccgggctgatgccgctcgcgaatggcttcttcccaactaccagcgcgataacctgcagatcctgactggccagaaggtcggaaaggttttgttcaaccagaccgcatctggacctaaggctgttggtgtgaacttcggtaccaacaaggctgttaacttcaatgtctacgccaagcaagaagttctgttggccgccggatctgccatttctcctttgatccttgaatactccggtattggtatcaagtccgtccttgacaaggccggtgttaagcagctcctcgaactccctgttggtctcaacatgcaagaccagaccactaccactgttcggtcccgcgccaacaacgcacctggacaaggccaggccgcttactttgccaacttcaccgaggttctcggcgaccacgccgcccagggtattaagttgctggacaccaagcttgaccagtgggccgaggagaccgttgcccgcggtggcttccacaatgtgactgccctcaagatccagtatgagaactaccgtaactggctccttgatgaggacgttgcatttgccgagctcttcttcgacactgagggcaagatcaactttgatatctggaatcttatccccttcactcgcggttccgtccacatcctcagcagtgacccttacctctggcaatacgcaaatgaccccaagttcttcatgaacgagctggatcttctcggccaggccgctgctactaagctgggtcgtgagctctctagcgctggtgagatgaagaagtactacgctggcgagaccatccccggcgacaacctgccccaggatgccaccgtcgagcagtgggaggactacgtgatgatgaacttccgtcctaactggcacgctgttagcacctgctctatgatgtcccgcgagcttggtggtgtcgtcgacgctactgccaaggtctacggtactcagggcctccgtgtcattgacggatctatccctcccactcaggtgtcctctcacgttatgaccgttttctacggtatggccttgcggatcgccgaatccgtccttgaagactatgccaagaaagcttaaa

SEQ ID NO: 3 - protein, 605 aa, Aspergillus tubingensis
MQTLFVSSLVVSLAAALPHYIRSNGIEASLLTDPKEVAGRTVDYIIAGGGLTGLTTAARLTENPDITVLVIESGSYESDRGPIIEDLNAYGDIFGSSVDHAYETVELATNNQTALIRSGNGLGGSTLVNGGTWTRPHKAQVDSWETVFGNEGWNWDSVAAYSLQAERARAPNAKQIAAGHYFNASCHGINGTVHAGPRDTGDDYSPIVKALMSAVEDRGVPTKKDLGCGDPHGVSMFPNTLHEDQVRSDAAREWLLPNYQRPNLQVLTGQYVGKVLLSQNATTPRAVGVEFGTHKGNTHNVYAKHEVLLAAGSAVSPTILEYSGIGMKSILEPLGIDTVVDLPVGLNLQDQTTSTVRSRITSAGAGQGQAAWFATFNETFGDYAEKAHELLNTKLEQWAEEAVARGGFHNTTALLIQYENYRDWIVKDNVAYSELFLDTAGVASFDVWDLLPFTRGYVHILDKDPYLRHFAYDPQYFLNELDLLGQAAATQLARNISNSGAMQTYFAGETIPGDNLAYDADLSAWVEYIPYNFRPNYHGVGTCSMMPKEMGGVVDNAARVYGVQGLRVIDGSIPPTQMSSHVMTVFYAMALKIADAILADYASMQ

(19) United States
(12) Patent Application Publication
(10) Pub. No.: US 2017/0273316 A1
(43) Pub. Date: Sep. 28, 2017

(54) COMBINATION OF GLUCOSE OXIDASES FOR IMPROVEMENTS IN BAKING

(71) Applicant: DSM IP ASSETS B.V., Heerlen (NL)

(72) Inventors: José DIAS PERES, Echt (NL); Caroline Hendrine Maria VAN BENSCHOP, Echt (NL); Soon Hee ONG, Echt (NL); Lambertus Gerhard STRUBBE, Echt (NL)

(21) Appl. No.: 15/504,992

(22) PCT Filed: Aug. 18, 2015
(86) PCT No.: PCT/EP2015/068916

§ 371 Date: Feb. 17, 2017

(30) Foreign Application Priority Data
Aug. 21, 2014 (CN) 201410415233.8
Sep. 3, 2014 (EP) 14183379.8
Oct. 6, 2014 (CN) 201410523216.6

(51) Int. Cl. A21D 8/04; A21D 10/00

(52) U.S. Cl. CPC A21D 8/042; C12Y 101/03004; A21D 10/005

(57) ABSTRACT

The present invention relates to the use of a Penicillium glucose oxidase in combination with another glucose oxidase for improving the stability of a dough, or the volume or the crumb structure of a baked product.

### FIELD OF THE INVENTION

The present invention relates to application of glucose oxidase in the baking industry.

### BACKGROUND OF THE INVENTION

Glucose oxidases (GOX) catalyze the oxidation of glucose and water into gluconic acid and hydrogen peroxide (H2O2) using atmospheric oxygen. For many years glucose oxidases have been used in the baking industry as processing aids in particular to strengthen the gluten network. Active oxygen in the hydrogen peroxide oxidizes thiol groups (SH-groups) in the gluten protein into disulfide bridges (cysteine), thus strengthening the dough made from the flour. Active oxygen in the hydrogen peroxide oxidizes the thiol groups (SH-groups) present in cysteine in the gluten protein into disulfide bridges (cystine), thus strengthening the dough made from the flour.

Flour having low protein content is usually classified as weak. The gluten of weak flour is very extensible under stress but does not return to its original dimensions when the stress is removed. Flour with high protein content is classified as strong. The gluten of strong flour is less extensible than that of weak flour. It is more resistant to mixing.

Strong flour is often preferred for baking purposes, since the rheological and handling properties of dough prepared from such flour are superior to those obtained with weak flour. In addition, the shape and texture of a bakery product prepared from strong flour are remarkably better as compared with weak flour.

A dough prepared from strong flour is also more stable as compared with that prepared from weak flour. This is one of the most important—if not the most important—properties in view of the baking process.

Although the stability of dough can be improved by glucose oxidase, the volume and texture of the baked product obtained from the dough usually do not suffice and stability improvements may not be effective under demanding circumstances.

### SUMMARY OF THE INVENTION

The present invention relates to the use of a Penicillium glucose oxidase in combination with another glucose oxidase for improving the stability, volume or the crumb structure of a baked product.

Stability herein is referring to stability of a dough. So the present invention relates to the use of a Penicillium glucose oxidase in combination with another glucose oxidase for improving the stability of a dough, or the volume of a baked product or the crumb structure of a baked product.

In a first aspect, the invention relates to the use of a composition comprising a combination of glucose oxidases for improving the stability, volume or crumb structure of a baked product.

In another aspect, the invention relates to the use of a combination of glucose oxidases for improving the stability, volume or crumb structure of a baked product, wherein at least one of the glucose oxidases is a Penicillium glucose oxidase. Thus the invention relates to the use of a combination of glucose oxidases for improving the stability of a dough, or the volume of a baked product or crumb structure of a baked product, wherein at least one of the glucose oxidases is a Penicillium glucose oxidase.

In another aspect, the invention relates to a method for improving a flour or pre-mix, which method comprises adding to the flour or pre-mix a Penicillium glucose and a second glucose oxidase.

In another aspect, the invention relates to a pre-mix or flour comprising a Penicillium glucose oxidase and a second glucose oxidase.

In another aspect, the invention relates to a method for preparing a dough comprising combining a pre-mix or a flour to which a Penicillium glucose oxidase and a second glucose oxidase were added, with at least one dough ingredient.

In another aspect, the invention relates to dough comprising a Penicillium glucose oxidase and a second glucose oxidase.

In another aspect, the invention relates to a method for preparing a baked product comprising the step of baking the dough according to the invention.

In another aspect, the invention relates to a baked product prepared from a pre-mix, a flour or a dough to which a Penicillium glucose oxidase and a second glucose oxidase were added.

### DESCRIPTION OF THE SEQUENCE LISTING

SEQ ID No.1 sets out the amino acid sequence of the Penicillium glucose oxidase used in the method according to the invention. Amino acids 1 to 18 represent the signal sequence used for secretion of the Penicillium glucose oxidase enzyme (amino acids 19-604).

SEQ ID No.2 sets out the cDNA sequence encoding the Penicillium glucose oxidase depicted in FIG. 1. Nucleotides 1 to 54 encode the signal sequence, nucleotides 55 to 1816 encode the mature glucose oxidase, including a translational termination sequence (5′-TAAA-3′) at the 3′-terminus.

SEQ ID No.3 sets out the amino acid sequence of an Aspergillus glucose oxidase.

### SHORT DESCRIPTION OF THE FIGURES

FIG. 1. Amino acid sequence of the Penicillium glucose oxidase used in the method according to the invention. Amino acid sequence of the Penicillium glucose oxidase used in the invention. Amino acids 1 to 18 represent the signal sequence used for secretion of the glucose oxidase (amino acids 19-604).

FIG. 2. cDNA sequence encoding the Penicillium glucose oxidase depicted in FIG. 1. Nucleotides 1 to 54 encode the signal sequence, nucleotides 55 to 1816 encode the mature glucose oxidase, including a translational termination sequence (5′-TAAA-3′) at the 3′-terminus.

FIG. 3. Amino acid sequence of an Aspergillus glucose oxidase used in the invention.

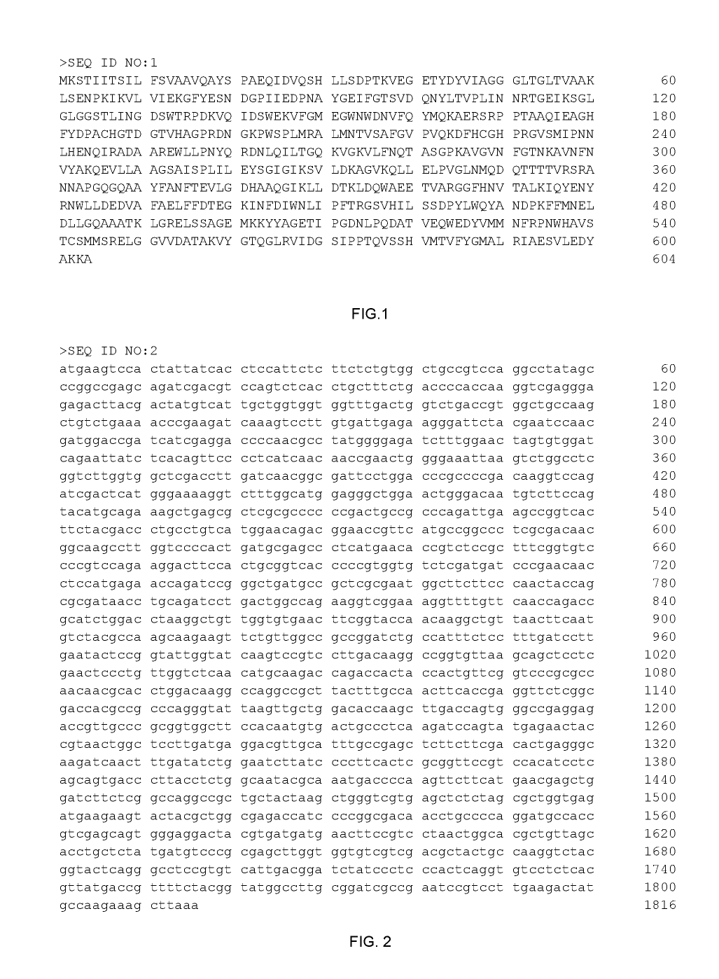

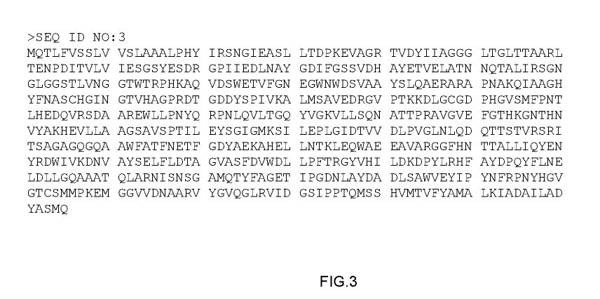

### DETAILED DESCRIPTION OF THE INVENTION

Throughout the present specification and the accompanying claims, the words “comprise”, “include” and “having” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element.

The present invention relates to the use of a combination of glucose oxidases for improving the volume or crumb structure of a baked product. The invention also relates to the use of a combination of glucose oxidases for improving stability of a dough.

The invention relates to the use of a Penicillium glucose oxidase in combination with another glucose oxidase for improving the stability of a dough, or the volume of a baked product or the crumb structure of a baked product.

The invention relates to the use of a combination of glucose oxidases for improving the stability of a dough, or the volume of a baked product or crumb structure of a baked product, wherein at least one of the glucose oxidases is a Penicillium glucose oxidase.

In an aspect the invention relates to the use of a combination of glucose oxidases for improving the stability of a dough, wherein at least one of the glucose oxidases is Penicillium glucose oxidase comprising an amino acid sequence having at least 75% identity to amino acids 19 to 604 of SEQ ID NO. 1 and a second glucose oxidase, wherein the second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3. In an aspect of said use the second glucose oxidase is an Aspergillus glucose oxidase comprising an amino acid sequence as set out in SEQ ID NO: 3. In an aspect of said use the second glucose oxidase is the glucose oxidase from Aspergillus Niger.

In an aspect the invention relates to the use of a combination of glucose oxidases for improving the stability of a dough, wherein at least one of the glucose oxidases is Penicillium glucose oxidase comprising an amino acid sequence as set out in amino acids 19 to 604 of SEQ ID NO. 1 and a second glucose oxidase, wherein the second glucose oxidase is an Aspergillus glucose oxidase comprising an amino acid sequence having at least 95% identity, at least 96% identity, at least 97% identity, at least 98% identity or at least 99% identity to the amino acid sequence as set out in SEQ ID NO: 3.

In an aspect the invention relates to a dough comprising a Penicillium glucose oxidase comprising an amino acid sequence having at least 75% identity to amino acids 19 to 604 of SEQ ID NO. 1 and a second glucose oxidase, wherein the second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3. In an aspect said dough comprises as the second glucose oxidase an Aspergillus glucose oxidase comprising an amino acid sequence as set out in SEQ ID NO: 3. In an aspect said dough comprises as the second glucose oxidase the glucose oxidase from Aspergillus Niger.

The invention further relates to dough comprising a Penicillium glucose oxidase comprising an amino acid sequence as set out in amino acids 19 to 604 of SEQ ID NO. 1 and a second glucose oxidase, wherein the second glucose oxidase is an Aspergillus glucose oxidase comprising an amino acid sequence having at least 95% identity, at least 96% identity, at least 97% identity, at least 98% identity or at least 99% identity to the amino acid sequence as set out in SEQ ID NO: 3.

The invention relates to a method for increasing dough stability comprising the step of combining a Penicillium glucose oxidase, a second glucose oxidase and at least one dough ingredient.

In an aspect the invention relates to a method for increasing dough stability comprising the step of combining a Penicillium glucose oxidase, a second glucose oxidase and at least one dough ingredient wherein the Penicillium glucose oxidase comprises an amino acid sequence having at least 75% identity to amino acids 19 to 604 of SEQ ID NO. 1 and a second glucose oxidase, wherein the second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3. In an aspect of said method the second glucose oxidase is an Aspergillus glucose oxidase comprising an amino acid sequence as set out in SEQ ID NO: 3. In an aspect of said method the second glucose oxidase is the glucose oxidase from Aspergillus Niger.

The invention also relates to a method for increasing dough stability comprising the step of combining at least one dough ingredient, a Penicillium glucose oxidase comprising an amino acid sequence as set out in amino acids 19 to 604 of SEQ ID NO. 1 and a second glucose oxidase, preferably wherein the second glucose oxidase is an Aspergillus glucose oxidase comprising an amino acid sequence having at least 95% identity, at least 96% identity, at least 97% identity, at least 98% identity or at least 99% identity to the amino acid sequence as set out in SEQ ID NO: 3.

In an aspect the combination of glucose oxidases has a synergistic positive effect on the stability of the dough, and/or the volume of a baked product and/or the crumb structure of a baked product. In an aspect the combination of glucose oxidases has a synergistic positive effect on the stability, volume and crumb structure of a baked product.

An improvement herein means as compared to a reference.

The reference is the situation not comprising the combination of glucose oxidases, e.g. use without the combination of glucose oxidases, a dough prepared without the combination of glucose oxidases, a flour not comprising the combination of glucose oxidases, a dough not comprising the combination of glucose oxidases, a baked product prepared without the combination of glucose oxidases.

In an aspect a comparison is made with the individual glucose oxidases. In an aspect the improvement is shown by the effect of the combination of glucose oxidases is more than the sum of the effect of a first glucose oxidase and the effect of the second glucose oxidase.

In an aspect the improvement is shown by the effect of a combination of an amount X of a first glucose oxidase and an amount Y of a second glucose oxidase being more than the effect of 2X of the first glucose oxidase.

In an aspect the improvement is shown by the effect of a combination of an amount X of a first glucose oxidase and an amount Y of a second glucose oxidase being more than the effect of 2Y of the second glucose oxidase.

In an aspect the improvement is shown by the effect of a combination of 5 ppm of a first glucose oxidase and 5 ppm a second glucose oxidase being more than the effect of 10 ppm of the first glucose oxidase.

For example the improvement may be shown by the effect of a combination of 5 ppm of a first glucose oxidase and 5 ppm a second glucose oxidase being more than the effect of 10 ppm of the second glucose oxidase.

For example the improvement may be shown by the effect of a combination of 10 ppm of a first glucose oxidase and 10 ppm a second glucose oxidase being more than the effect of 20 ppm of the first glucose oxidase. For example the improvement may be shown by the effect of a combination of 10 ppm of a first glucose oxidase and 10 ppm a second glucose oxidase being more than the effect of 20 ppm of the second glucose oxidase.

Ppm is herein is based on flour weight.

Stability herein is referring to stability of a dough. In the context of the present invention, the term “increased stability of the dough” means that the dough is less susceptible to forming faults as a consequence of a (mechanical) handing process and/or a freezing process as compared to a reference dough. This may be observed by the shaped dough maintaining better its shape during the time from before entering the oven until after baking.

Before entering the oven herein means of from half an hour before until 1 minute before entering the oven. In an aspect before entering the oven means of from 15 minutes before until 1 minute before entering the oven, in an aspect of from 5 minutes before until 2 minutes before entering the oven.

Alternatively the stability of the dough may be evaluated by determining the diameter to height (D:H) ratio of the product baked from the dough, which is the average diameter divided by the height.

$$diameter to height ( D \text{:} H ) ratio = \frac{average diameter}{height}$$

The average diameter is determined by measuring the diameter in one direction and adding to this the diameter perpendicular to the one direction and dividing the sum of the diameters by two. All diameters and heights are measured on the surface of the non-sliced (i.e. whole) product. The D:H ratio of a baked product prepared from a dough comprising a combination of glucose oxidases may be more favourable than the D:H ratio of a baked product prepared from a frozen dough not comprising a combination of glucose oxidases. This may been observed even after a long period of freezing of the dough. For rolls, a D:H ratio of 1.4-1.7 is favourable.

Stability of the dough may be evaluated by comparing the shape of the dough before it enters the oven and the shape of the baked product obtained after baking. Stability of the dough is improved if these shapes are more similar, i.e differ less from each other, than the corresponding shapes of the reference. This can for example be determined by comparing the diameter to height ratio (D:H) of the dough and the baked product made from the dough as described herein. If these ratios are similar, the shapes of the dough and the baked product are considered to be similar.

For a baked product baked on a plate (e.g. in a direct floor baking process) the stability of the dough may be evaluated by looking at the roundness of the base of the baked product. Whereby the base is the part of the dough or baked product that rests on the plate. A rounder shape of the base indicates a better stability of the dough. Alternatively stability of the dough may be evaluated by determining the contact area of the base of the baked product with a surface (e.g. floor plate) on which it rests, a smaller contact area indicates an increased stability of the dough.

Improved dough stability may be demonstrated by an improved shock resistance of a dough. Improved shock resistance of a dough may be demonstrated as follows. Bread tins filled with proofed dough are dropped from a certain drop-height, e.g. 9 cm height, just before they enter the oven to be baked. This may be done by simultaneously pulling away 2 blocks having this drop-height from below the bottom of the tin. This way the tin drops over the drop-height and the dough experiences a shock. The shock resistance of a dough is improved if, after baking the dough, the volume of the loaf is larger as compared to a reference loaf (which may also be called a control) loaf and/or the hardness of the loaf after baking the dough is lower as compared to a reference loaf (which may also be called a control).

In improved volume of the baked product herein means a larger volume of the baked product as compared to a reference product. The volume of the baked product may be determined by an automated bread volume analyser (such as an BVM-3, TexVol Instruments).

During preparation (e.g. mixing), fermentation and baking of the dough the cells are formed and developed to result in a crumb structure of a baked product. Crumb structure is important property of a baked product such as bread or cake is crumb structure. Crumb structure herein is used to describe the inside of a baked product such as bread or cake. Crumb structure is at the way the cell structure of the crumb is formed, and the shape and size of the cells.

Different baked product applications benefit from a different crumb structure. There is therefore a need to improve the crumb structure of a baked product. In certain applications it is desired that the baked product has finer crumb structure. Therefore in an aspect an improved crumb structure herein includes a finer crumb structure as compared to a reference product.

Crumb structure may be evaluated for example by digital image analysis as known in the art (eg. C-cell, Calibre Control International Ltd, Appleton, Warrington, UK).

Crumb structure may be evaluated visually by a baker.

The following parameters may be used in evaluating crumb structure: area of holes, number of cells, average cell diameter, coarse/fine clustering.

The parameter concerning evaluation of the crumb structure may be determined my digital analysis of a slice of baked product e.g. a slice of bread or cake.

In an aspect when comparing parameters of a baked product with a reference baked product, the parameter is normalized with respect to the total surface area of the reference slice of baked product that was analyzed. The total surface area of a slice of bread may be provided by the digital analysis apparatus or may be established by multiplying the height and the width of the slice involved.

In an aspect when comparing parameters of a baked product with a reference baked product, the parameter is normalized with respect to the volume of the reference baked product that was analyzed. The volume of the baked product may be determined by an automated bread volume analyser (such as an BVM-3, TexVol Instruments).

A finer crumb structure of a baked product may be shown by the area of holes, as determined by digital image analysis, being smaller than the area of holes of a reference baked product.

A finer crumb structure of a baked product may be shown by a smaller number of cells, as determined by digital image analysis, than the number of cells of a reference baked product.

A finer crumb structure of a baked product may be shown by a smaller average cell diameter, as determined by digital image analysis, than the average cell diameter of a reference baked product.

A finer crumb structure of a baked product may be shown by the average cell diameter of a baked product, as determined by digital image analysis, having a smaller standard deviation than a reference baked product.

A finer crumb structure of a baked product may be shown by more uniform/homogenous distribution of cells as compared to a reference baked product.

A finer crumb structure of a baked product herein includes smaller cells, smaller holes and/or less holes as compared to a reference baked product.

In an aspect a finer crumb structure of a baked product herein includes smaller cells, smaller holes and less holes as compared to a reference baked product.

In an aspect a finer crumb structure of a baked product herein includes smaller cells, smaller holes, less holes and a more uniform/homogenous distribution of cells as compared to a reference baked product.

In one embodiment, a Penicillium glucose oxidase is used in combination with second glucose oxidase for improving the volume or crumb structure of a baked product. The second glucose oxidase may be obtainable from a filamentous fungus, such as from a Acremonium, Agaricus, Aspergillus, Aureobasidium, Chrysosporium, Coprinus, Cryptococcus, Filibasidium, Fusarium, Humicola, Magnaporthe, Mucor, Myceliophthora, Neocallimastix, Neurospora, Paecilomyces, Piromyces, Panerochaete, Pleurotus, Rasamsonia, Schizophyllum, Talaromyces, Thermoascus, Thielavia, Tolypocladium, and Trichoderma. In another embodiment, the second glucose oxidase is obtainable from an Aspergillus, Chrysosporium, Myceliophthora, Penicillium, Talaromyces, Fusarium, Rasamsonia, Thermoascus or Trichoderma genus. In another embodiment, the second glucose oxidase is obtainable from an Aspergillus niger, Aspergillus awamori, Aspergillus foetidus, Aspergillus sojae, Aspergillus fumigatus, Aspergillus oryzae, Aspergillus tubingensis, Fusarium oxysporum, Myceliophthora thermophila, Rasamsonia emersonii, Trichoderma reesei, Talaromyces emersonii, Thermoascus aurantiacus. These glucose oxidases are referred to as Acremonium glucose oxidase, Aspergillus glucose oxidase etc.

A Penicillium glucose oxidase for use according to the invention may be obtained by any suitable means. In one embodiment, it is isolated from a source, in particular a prokaryotic or eukaryotic microorganism, containing the enzyme. Suitable examples of microorganisms are mammalian, plant, fungal and algal microorganisms as mentioned below. In one embodiment, the Penicillium glucose is isolated from a Penicillium species, in particular from Penicillium chrysogenum. A suitable example of such a Penicillium glucose oxidase is a Penicillium glucose oxidase comprising an amino acid sequence according to amino acids 19-604 of SEQ ID NO. 1, or a glucose oxidase with an amino acid sequence which shows at least 75% identity to amino acids 19-604 of SEQ ID No.1. In one embodiment, the glucose oxidase has an amino acid sequence which shows at least 80%, at least 85%, at least 90%, at least 95%, at least 97%, at least 98% or at least 99% identity to amino acids 19-604 of SEQ ID NO. 1.

In another embodiment, the Penicillium glucose oxidase is generated using standard molecular biology techniques to provide a glucose oxidase which would otherwise be obtainable from a Penicillium fungus, e.g. by de novo synthesis of a nucleotide sequence according to SEQ ID No. 2 or a nucleotide sequence which encodes a protein having an amino acid sequence having at least 75%, at least 80%, at least 85%, at least 90%, at least 95%, at least 97%, at least 98% or at least 99% identity to amino acids 19-604 of SEQ ID No.1. In one embodiment, a nucleotide sequence according to SEQ ID No. 2 is used. Such a nucleotide sequence may then be used for transformation of a host microorganism. In another embodiment, the Penicillium glucose oxidase is generated using site-saturation mutagenesis, scanning mutagenesis, insertional mutagenesis, random mutagenesis, site-directed mutagenesis, and directed-evolution of an existing glucose oxidase, e.g. of the one depicted in SEQ ID NO. 1, as well as various other recombination approaches known to a skilled person in the art. Glucose oxidases (EC 1.1.3.4) catalyse the oxidation of glucose into gluconic acid and hydrogen peroxide using atmospheric oxygen.

In an aspect the Aspergillus glucose oxidase is the glucose oxidase from Aspergillus Niger. In an aspect the second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3. In an aspect the second glucose oxidase is an Aspergillus glucose oxidase comprising an amino acid sequence as set out in SEQ ID NO: 3.

In the context of the present invention, in order to determine the percentage of sequence identity of two amino acid sequences or of two nucleic acid sequences, the sequences are aligned for optimal comparison purposes. In order to optimize the alignment between the two sequences, gaps may be introduced in any of the two sequences that are compared. Such alignment may be carried out over the full length of the sequences being compared. Alternatively, the alignment may be carried out over a shorter length, for example over about 20, about 50, about 100 or more nucleic acids/bases or amino acids. The sequence identity is the percentage of identical matches between the two sequences over the reported aligned region. Upon the alignment of two sequences, the resulting aligned amino acid positions are usually referred to as corresponding positions. The percent sequence identity between two amino acid sequences or between two nucleotide sequences may be determined using the Needleman and Wunsch algorithm for the alignment of two sequences. (Needleman, S. B. and Wunsch, C. D. (1970) J. Mol. Biol. 48, 443-453). Both amino acid sequences and nucleotide sequences can be aligned by the algorithm. The Needleman-Wunsch algorithm has been implemented in the computer program NEEDLE. For the purpose of this invention the NEEDLE program from the EMBOSS package was used (version 2.8.0 or higher, EMBOSS: The European Molecular Biology Open Software Suite (2000) Rice, P. Longden, I. and Bleasby, A. Trends in Genetics 16, (6) p. 276-277, http://emboss.bioinformatics.nl/). For protein sequences EBLOSUM62 is used for the substitution matrix. For nucleotide sequences, EDNAFULL is used. The optional parameters used are a gap-open penalty of 10 and a gap extension penalty of 0.5. The skilled person will appreciate that all these different parameters will yield slightly different results but that the overall percentage identity of two sequences is not significantly altered when using different algorithms.

After alignment by the program NEEDLE as described above the percentage of sequence identity between a query sequence and a sequence of the invention is calculated as follows: Number of corresponding positions in the alignment showing an identical amino acid or identical nucleotide in both sequences divided by the total length of the alignment after subtraction of the total number of gaps in the alignment. The identity as defined herein can be obtained from NEEDLE by using the NOBRIEF option and is labeled in the output of the program as “longest-identity”.

The nucleic acid and protein sequences of the present invention can further be used as a “query sequence” to perform a search against public databases to, for example, identify other family members or related sequences. Such searches can be performed using the NBLAST and XBLAST programs (version 2.0) of Altschul, et al. (1990) J. Mol. Biol. 215:403-10. BLAST nucleotide searches can be performed with the NBLAST program, score=100, word length=12 to obtain nucleotide sequences similar to nucleic acid molecules of the invention. BLAST protein searches can be performed with the XBLAST program, score=50, word length=3 to obtain amino acid sequences similar to protein molecules of the invention. To obtain gapped alignments for comparison purposes, Gapped BLAST can be utilized as described in Altschul et al., (1997) Nucleic Acids Res. 25(17): 3389-3402. When utilizing BLAST and Gapped BLAST programs, the default parameters of the respective programs (e.g., XBLAST and NBLAST) can be used. See the homepage of the National Center for Biotechnology Information at http://www.ncbi.nlm.nih.gov/.

Any microorganism may be used as a recombinant host cell to produce a the glucose oxidases, such as a Penicillium glucose oxidase, for use according to the invention. In one embodiment, the microorganism is a prokaryotic cell, such as a Gram-negative or Gram-positive bacterium. Suitable bacteria include Escherichia, Anabaena, Caulobactert, Cyanobacteria, Gluconobacter, Rhodobacter, Pseudomonas, Paracoccus, Bacillus, Brevibacterium, Corynebacterium, Rhizobium (Sinorhizobium), Flavobacterium, Klebsiella, Enterobacter, Lactobacillus, Lactococcus, Methylobacterium, Moraxella, Neisseria, Staphylococcus, Streptomyces or Thermoactinomyces. In another embodiment, the microorganism is a eukaryotic cell, such as a mammalian cell, insect cell, plant cell, fungal cell or algal cell. Suitable examples of mammalian cells are CHO cells, COS cells, 293 cells, Per.C6® cells, and hybridomas. Suitable examples of insect cells include Sf9 and Sf21 cells and derivatives thereof. Suitable examples of fungal cells include yeast cells, such as Candida, Hansenula, Kluyveromyces, Pichia, Saccharomyces, Schizosaccharomyces, or Yarrowia strain; more preferably Kluyveromyces lactis, S. cerevisiae, Hansenula polymorpha, Yarrowia lipolytica and Pichia pastoris, or a filamentous fungi. Filamentous fungi include all filamentous forms of the subdivision Eumycota and Oomycota (as defined by Hawksworth et al., In, Ainsworth and Bisby's Dictionary of The Fungi, 8th edition, 1995, CAB International, University Press, Cambridge, UK). Filamentous fungal strains include strains of Acremonium, Agaricus, Aspergillus, Aureobasidium, Chrysosporium, Coprinus, Cryptococcus, Filibasidium, Fusarium, Humicola, Magnaporthe, Mucor, Myceliophthora, Neocallimastix, Neurospora, Paecilomyces, Penicillium, Piromyces, Panerochaete, Pleurotus, Rasamsonia, Schizophyllum, Talaromyces, Thermoascus, Thielavia, Tolypocladium, and Trichoderma. Preferred filamentous fungal cells belong to a species of an Aspergillus, Chrysosporium, Myceliophthora, Penicillium, Talaromyces, Fusarium, Rasamsonia, Thermoascus or Trichoderma genus, and most preferably a species of Aspergillus niger, Aspergillus awamori, Aspergillus foetidus, Aspergillus sojae, Aspergillus fumigatus, Aspergillus oryzae, Fusarium oxysporum, Myceliophthora thermophila, Rasamsonia emersonii, Trichoderma reesei, Talaromyces emersonii, Thermoascus aurantiacus or Penicillium chrysogenum. Algae is the group of unicellular and multicellular eukaryortic photosynthetic organisms, including microalgae, such as Dunaliella, Spirulina and Chlorella. In one embodiment, the recombinant host cell comprising a nucleotide sequence or a nucleic acid molecule according to the invention is an Aspergillus, Bacillus, Chrysosporium, Escherichia, Kluyveromyces, Myceliophthora, Penicillium, Pseudomonas, Rasamsonia, Saccharomyces, Streptomyces or Talaromyces species, preferably a Bacillus subtilis, Bacillus amyloliquefaciens, Bacillus licheniformis, Escherichia coli, Aspergillus niger, Aspergillus oryzae, Myceliophthora thermophila, Rasamsonia emersonii or Trichoderma reesei species. The recombinant host cell is preferably capable of expressing or overexpressing the glucose oxidase. The recombinant host cell may further comprise one or more modifications in its genome such that the recombinant microbial host cell is deficient in the production of at least one product selected from glucoamylase (glaA), acid stable alpha-amylase (amyA), neutral alpha-amylase (amyBI and amyBII), oxalic acid hydrolase (oahA), a toxin, preferably ochratoxin and/or fumonisin, a protease transcriptional regulator prtT, PepA, a product encoded by the gene hdfA and/or hdfB, a non-ribosomal peptide synthase npsE, agsE or amyC if compared to a parent host cell and measured under the same conditions. Suitable methods of producing said host cells include the ones described in WO2012/001169 and WO2014013074.

The glucose oxidases used in the present invention may be fusion proteins. Techniques for producing fusion polypeptides are known in the art, and include ligating the coding sequences encoding the polypeptides so that they are in frame. Expression of the fused polypeptide is under control of the same promoter(s) and terminator. The hybrid polypeptides may comprise a combination of partial or complete polypeptide sequences obtained from at least two different polypeptides wherein one or more may be heterologous to a host cell. Such fusion polypeptides from at least two different polypeptides may comprise a binding domain from one polypeptide, such as a starch binding domain or a carbohydrate binding domain, operably linked to a catalytic domain from a second polypeptide. Examples of fusion polypeptides and signal sequence fusions are for example as described in WO2010/121933, WO2013/007820 and WO2013/007821.

In the context of the present invention the term ‘polypeptide’ refers to a molecule which contains a backbone of a chain of at least ten amino acids, wherein the amino acids are covalently linked to each other by peptide bonds. These backbone amino acids groups may be linked to other groups, such as other amino acid sequences, sugar groups or lipid groups. The polypeptide may contain structural features, such as alpha-helices, beta-pleated sheets or disulphide bridges. A polypeptide used according to the present invention may comprise a catalytic domain and one or more binding domains, such as a starch or carbohydrate binding domain. In the context of the present invention, the amino acid sequence is also referred to as ‘polypeptide sequence’ or ‘protein sequence’. The term ‘polypeptide’ includes proteins.

In the Figures and in other places of the description of the present invention, the one letter code for amino acids is used, where A stands for Alanine, I for Isoleucine, L for Leucine, V for Valine, S for Serine, G for Glycine, P for Proline, Q for Glutamine, E for Glutamic acid, R for Arginine, D for Aspartic acid, K for Lysine, N for Asparagine, Y for Tyrosine, H for Histidine, F for Phenylalanine, C for Cysteine, T for Threonine. In the one letter code for amino acids M stands for Methionine, W for Tryptophan. Such one letter codes are commonly known in the art, see e.g. Sambrook, et al. (Molecular Cloning: A Laboratory Manual, 2^{nd} ed. Cold Spring Harbor Laboratory, Cold Spring Harbor Laboratory Press, Cold Spring Harbor, N.Y., 1989).

The glucose oxidases for use according to the invention may be comprised in a composition. The composition may comprise between 0.001% and 100% w/w of glucose oxidases based on total protein. Preferably, the composition comprises between 1% and 70% w/w of glucose oxidases based on total protein. In one embodiment, the composition comprises between 1% and 50% w/w of glucose oxidases based on total protein. In yet another embodiment, the composition comprises between 1% and 30% w/w of glucose oxidases based on total protein. In yet another embodiment, the composition comprises between 5% and 20% w/w of glucose oxidases based on total protein. The glucose oxidases in the composition may be present in any suitable ratio. In one embodiment, the composition comprises two different glucose oxidases which are present in equal amounts, based on ppm. In another embodiment, the composition comprises two different glucose oxidases which are present in a ratio of between 1:10 and 10:1, such as 2:3 or 3:2, or 1:2 or 2:1 or 1:5 or 5:1, based on ppm.

The glucose oxidases for use according to the invention may be comprised in a composition. The composition may comprise between 0.001% and 100% w/w of glucose oxidases based on total enzyme protein. Preferably, the composition comprises between 1% and 70% w/w of glucose oxidases based on total enzyme protein. In one embodiment, the composition comprises between 1% and 50% w/w of glucose oxidases based on total enzyme protein. In yet another embodiment, the composition comprises between 1% and 30% w/w of glucose oxidases based on total enzyme protein. In yet another embodiment, the composition comprises between 5% and 20% w/w of glucose oxidases based on total enzyme protein. The glucose oxidases in the composition may be present in any suitable ratio. In one embodiment, the composition comprises two different glucose oxidases which are present in equal amounts, based on ppm. In another embodiment, the composition comprises two different glucose oxidases which are present in a ratio of between 1:10 and 10:1, such as 2:3 or 3:2, or 1:2 or 2:1 or 1:5 or 5:1, based on ppm. Total enzyme protein refers to all enzyme protein present in the composition.

In one embodiment of the invention, the glucose oxidases are the only enzymatic components in the composition. In another embodiment of the invention, the composition comprises a combination of glucose oxidases and at least one additional enzymatic activity. The at least one additional enzyme activity may be selected from enzymes like a protease, such as a endoprotease or an exoprotease; a peptidase, such as an exopeptidase or an endopeptidase; a lipolytic enzyme, such as a triacyl glycerol lipase, a phospholipase, a galactolipase or an enzyme having both phospholipase and galactolipase activity; or a carbohydrase, such as a cellulase, a hemicellulase, in particular a pentosanase such as a xylanase; a cross-linking enzyme, such as a transglutaminase; a maltogenic alpha amylase; an alpha amylase; a beta amylase; an amyloglucosidase, an oxidase, such as a sulfhydryl oxidase, a pyranose oxidase; a peroxidase, a hexose oxidase, a laccase; a protein disulfide isomerase; an asparaginase. The composition may suitably be used as flour improving composition.

In one embodiment, the flour improving composition further comprises one or more components selected from the group consisting of milk powder, gluten, granulated fat, an additional enzyme, an amino acid, a salt, an oxidant such as ascorbic acid, bromate and azodicarbonamide; a reducing agent such as L-cysteine, an emulsifier such as mono-glycerides, di-glycerides, glycerol monostearate, sodium stearoyl lactylate, calcium stearoyl lactylate, polyglycerol esters of fatty acids and diacetyl tartaric acid esters of mono- and diglycerides, gums such as guar gum and xanthan gum, flavours, acids such as citric acid and propionic acid, starch, modified starch, gluten, humectants such as glycerol, and preservatives. The flour improving composition may comprise propylene glycerol monostearate. In another embodiment, the composition comprises comprises a lipolytic enzyme, preferably a phospholipase.

The composition comprising a combination of glucose oxidases, such as a Penicillium glucose oxidase and a second glucose oxidase, may be formulated in any suitable form. In one embodiment, the composition comprising Penicillium glucose oxidase, such as a Penicillium glucose oxidase comprising an amino acid sequence which shows at least 75%, at least 80%, at least 85%, at least 90%, at least 95%, at least 97%, at least 98% or at least 99% identity to amino acids 19-604 of SEQ ID NO. 1, and a second glucose oxidase, such as a fungal or Aspergillus glucose oxidase is formulated in a dry form, such as a freeze-dried or spray-dried powder or a granulate. In another embodiment, the composition according to the invention is in liquid form, such as in the form of an emulsion, a suspension or a solution. In yet another embodiment, the composition according to the invention is a paste or a gel.

In an aspect the composition comprising a combination of glucose oxidases comprises a Penicillium glucose oxidase.

In an aspect of the composition comprising a combination of glucose oxidases, at least one of the glucose oxidases is Penicillium glucose oxidase comprising an amino acid sequence having at least 75% identity to amino acids 19 to 604 of SEQ ID NO. 1 and a second glucose oxidase, and a second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3. In an aspect of said composition the second glucose oxidase is an Aspergillus glucose oxidase comprising an amino acid sequence as set out in SEQ ID NO: 3. In an aspect of said composition the second glucose oxidase is the glucose oxidase from Aspergillus Niger.

In an aspect of the composition comprising a combination of glucose oxidases, at least one of the glucose oxidases is Penicillium glucose oxidase comprising an amino acid sequence as set out in amino acids 19 to 604 of SEQ ID NO. 1 and a second glucose oxidase, wherein the second glucose oxidase is an Aspergillus glucose oxidase comprising an amino acid sequence having at least 95% identity, at least 96% identity, at least 97% identity, at least 98% identity or at least 99% identity to the amino acid sequence as set out in SEQ ID NO: 3.

The glucose oxidases may be included in a flour or pre-mix to obtain a flour or pre-mix which comprises a combination of glucose oxidases and which conveys improved properties to a dough made therefrom. Therefore, in another aspect, the present invention relates to a flour or pre-mix comprising a combination of glucose oxidases, such as a Penicillium glucose oxidase and a second glucose oxidase. The Penicillium glucose oxidase may be a Penicillium glucose oxidase comprising an amino acid sequence which shows at least 75%, at least 80%, at least 85%, at least 90%, at least 95%, at least 97%, at least 98% or at least 99% identity to amino acids 19-604 of SEQ ID NO. 1. The second glucose oxidase may suitably be a fungal, such as a filamentous fungal, or Aspergillus glucose oxidase. In an aspect the Aspergillus glucose oxidase is the glucose oxidase from Aspergillus Niger. In an aspect the second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3.

In an aspect the flour comprising a combination of glucose oxidases comprises a Penicillium glucose oxidase.

In an aspect of the flour comprising a combination of glucose oxidases, at least one of the glucose oxidases is Penicillium glucose oxidase comprising an amino acid sequence having at least 75% identity to amino acids 19 to 604 of SEQ ID NO. 1 and a second glucose oxidase, and a second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3. In an aspect of said flour the second glucose oxidase is an Aspergillus glucose oxidase comprising an amino acid sequence as set out in SEQ ID NO: 3. In an aspect of said flour the second glucose oxidase is the glucose oxidase from Aspergillus Niger.

In an aspect of the flour comprising a combination of glucose oxidases, at least one of the glucose oxidases is Penicillium glucose oxidase comprising an amino acid sequence as set out in amino acids 19 to 604 of SEQ ID NO. 1 and a second glucose oxidase, wherein the second glucose oxidase is an Aspergillus glucose oxidase comprising an amino acid sequence having at least 95% identity, at least 96% identity, at least 97% identity, at least 98% identity or at least 99% identity to the amino acid sequence as set out in SEQ ID NO: 3.

In an aspect the pre-mix comprising a combination of glucose oxidases comprises a Penicillium glucose oxidase.

In an aspect of the pre-mix comprising a combination of glucose oxidases, at least one of the glucose oxidases is Penicillium glucose oxidase comprising an amino acid sequence having at least 75% identity to amino acids 19 to 604 of SEQ ID NO. 1 and a second glucose oxidase, and a second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3. In an aspect of said pre-mix the second glucose oxidase is an Aspergillus glucose oxidase comprising an amino acid sequence as set out in SEQ ID NO: 3. In an aspect of said pre-mix the second glucose oxidase is the glucose oxidase from Aspergillus Niger.

In an aspect of the pre-mix comprising a combination of glucose oxidases, at least one of the glucose oxidases is Penicillium glucose oxidase comprising an amino acid sequence as set out in amino acids 19 to 604 of SEQ ID NO. 1 and a second glucose oxidase, wherein the second glucose oxidase is an Aspergillus glucose oxidase comprising an amino acid sequence having at least 95% identity, at least 96% identity, at least 97% identity, at least 98% identity or at least 99% identity to the amino acid sequence as set out in SEQ ID NO: 3.

In one embodiment, the flour comprises by weight of flour: a) 1 to 50 ppm of a Penicillium glucose oxidase and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a second glucose oxidase.

In another embodiment, the flour comprises by weight of flour: a) 1 to 50 ppm of a Penicillium glucose oxidase and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a filamentous fungal glucose oxidase.

In another embodiment, the flour comprises by weight of flour: a) 1 to 50 ppm of a Penicillium glucose oxidase and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of an Aspergillus glucose oxidase.

In another embodiment, the flour comprises by weight of flour: a) 1 to 50 ppm of a Penicillium glucose oxidase comprising an amino acid sequence as set out in amino acids 19 to 604 of SEQ ID NO. 1 and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a second glucose oxidase, wherein the second glucose oxidase is an Aspergillus glucose oxidase comprising an amino acid sequence having at least 95% identity to the amino acid sequence as set out in SEQ ID NO: 3.

In another embodiment, the flour comprises by weight of flour: a) 1 to 50 ppm of a Penicillium glucose oxidase comprising an amino acid sequence as set out in amino acids 19 to 604 of SEQ ID NO. 1 and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a second glucose oxidase, wherein the second glucose oxidase is an Aspergillus glucose oxidase comprising an amino acid sequence having at least 96% identity to the amino acid sequence as set out in SEQ ID NO: 3.

In another embodiment, the flour comprises by weight of flour: a) 1 to 50 ppm of a Penicillium glucose oxidase comprising an amino acid sequence as set out in amino acids 19 to 604 of SEQ ID NO. 1 and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a second glucose oxidase, wherein the second glucose oxidase is an Aspergillus glucose oxidase comprising an amino acid sequence having at least 97% identity to the amino acid sequence as set out in SEQ ID NO: 3.

In another embodiment, the flour comprises by weight of flour: a) 1 to 50 ppm of a Penicillium glucose oxidase comprising an amino acid sequence as set out in amino acids 19 to 604 of SEQ ID NO. 1 and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a second glucose oxidase, wherein the second glucose oxidase is an Aspergillus glucose oxidase comprising an amino acid sequence having at least 98% identity to the amino acid sequence as set out in SEQ ID NO: 3.

In another embodiment, the flour comprises by weight of flour: a) 1 to 50 ppm of a Penicillium glucose oxidase comprising an amino acid sequence as set out in amino acids 19 to 604 of SEQ ID NO. 1 and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a second glucose oxidase, wherein the second glucose oxidase is an Aspergillus glucose oxidase comprising an amino acid sequence having at least 99% identity to the amino acid sequence as set out in SEQ ID NO: 3.

In another embodiment, the flour comprises by weight of flour: a) 1 to 50 ppm of a Penicillium glucose oxidase comprising an amino acid sequence as set out in amino acids 19 to 604 of SEQ ID NO. 1 and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a second glucose oxidase, wherein the second glucose oxidase is an Aspergillus glucose oxidase comprising an amino acid sequence as set out in SEQ ID NO: 3.

In another embodiment, the flour comprises by weight of flour: a) 1 to 50 ppm of a Penicillium glucose oxidase comprising an amino acid sequence as set out in amino acids 19 to 604 of SEQ ID NO. 1 and b) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a second glucose oxidase, wherein the second glucose oxidase is an Aspergillus niger glucose oxidase.

The Penicillium glucose oxidase typically has an activity in the range of about 2500 to 4000 glucose oxidase units/gram enzyme when determined according to the assay described below. In one embodiment, the Penicillium glucose oxidase has an activity in the range of about 2800 to 4000 glucose oxidase units/gram enzyme. In another embodiment, the Penicillium glucose oxidase has an activity in the range of about 3000 to 4000 glucose oxidase units/gram enzyme. In yet another embodiment, the Penicillium glucose oxidase has an activity in the range of about 3000 to 3600 glucose oxidase units/gram enzyme. In yet another embodiment, the Penicillium glucose oxidase has an activity of about 3300 glucose oxidase units/gram enzyme. Glucose oxidase activity is determined in an assay in which gluconic acid formed is titrated. 1 ml of diluted glucose oxidase is added to 25 ml of preheated 30 g/I glucose monohydrate solution at 35 degrees C. Sample dilutions and substrate are prepared in 50 mM HAc buffer at pH 5.1, containing 50 mM NaCl. After 15 minutes incubation at 35 degrees C., the reaction is terminated by the addition of 10 ml 0.1 N NaOH, at the same time neutralizing the gluconic acid formed. Excess NaOH is titrated with 0.05 M HCl. The difference in HCl consumption between a sample and blank run is a measure for the amount of glucose oxidase activity. One glucose oxidase unit is defined as the amount of enzyme needed to oxidize 3 mg of glucose to gluconic acid under conditions of the assay. Glucose oxidase activities may be determined using alternative assays, such as spectrophotometrically at 450 nm using o-dianisidine as described by Witteveen et al. 1990 (“Glucose oxidase overproducing and negative mutants of Aspergillus niger”, Appl. Microbiol. Biotechnol 33:683-686) or a glucose oxidase assay as described in the Food Chemicals Codex (FCC).

The term “pre-mix” is defined herein to be understood in its conventional meaning, i.e. as a mix of baking agents, generally including flour, which may be used not only in industrial bread-baking plants/facilities, but also in retail bakeries. The pre-mix may be prepared by mixing the glucose oxidase or a composition according to the invention with a suitable carrier such as flour, starch or a salt. The pre-mix may contain additives as mentioned herein.

In another aspect, the present invention relates to a method for improving flour or a pre-mix, wherein the method comprises adding to the flour or pre-mix a composition comprising a combination of glucose oxidases, such as a Penicillium glucose oxidase and a second glucose oxidase, for improving the volume or crumb structure of a baked product. Improvements are always relative to flour or pre-mix to which no glucose oxidases are added. The Penicillium glucose may be a Penicillium glucose oxidase with an amino acid sequence which shows at least 75%, at least 80%, at least 85%, at least 90%, at least 95%, at least 97%, at least 98% or at least 99% identity to amino acids 19-604 of SEQ ID NO. 1. The second glucose oxidase may suitably be a fungal, such as a filamentous fungal, or Aspergillus glucose oxidase.

In one embodiment, the method comprises adding to the flour by weight of flour (i) 1 to 50 ppm of a Penicillium glucose oxidase and (ii) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a second glucose oxidase, such as a fungal or Aspergillus glucose oxidase.

In another embodiment, the method comprises adding to the flour by weight of flour (i) 1 to 50 ppm of a Penicillium glucose oxidase and (ii) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of a filamentous fungal glucose oxidase.

In another embodiment, the method comprises adding to the flour by weight of flour (i) 1 to 50 ppm of a Penicillium glucose oxidase and (ii) 1 to 200 ppm, 1 to 175 ppm, 1 to 150 ppm, 1 to 125 ppm, 1 to 100 ppm, 1 to 90 ppm, 1 to 80 ppm, 1 to 70 ppm, 1 to 60 ppm, 1 to 50 ppm, 1 to 50 ppm, 1 to 30 ppm, 1 to 20 ppm or 10 to 20 ppm of an Aspergillus glucose oxidase.

In one embodiment, 1 ppm-50 ppm by weight of flour of a Penicillium glucose oxidase having an activity in a range of about 2500-4000, of about 2800-4000, of about 3000-4000 or of about 3000-3600 glucose oxidase units/gram enzyme in combination with 1 to 200 ppm of a second glucose oxidase, such as fungal, such as a filamentous fungal, or an Aspergillus glucose oxidase, is used to improve the flour. In another embodiment, 1 ppm-20 ppm by weight of flour of a Penicillium glucose oxidase having an activity in a range of about 2500-4000, of about 2800-4000, of about 3000-4000 or of about 3000-3600 glucose oxidase units/gram enzyme in combination with 1 to 20 ppm of a second glucose oxidase, such as fungal, such as a filamentous fungal, or an Aspergillus glucose oxidase is used to improve the flour. The second glucose oxidase may be added simultaneously, sequentially, before or after the Penicillium glucose oxidase.

A flour or pre-mix according to the invention may be used to produce a dough according to the invention. Therefore, in yet another aspect, the present invention relates to a dough prepared from a pre-mix or flour comprising a combination of glucose oxidases, such as a Penicillium glucose oxidase and a second glucose oxidase. The Penicillium glucose oxidase may be a a Penicillium glucose oxidase comprising an amino acid sequence which shows at least 75%, at least 80%, at least 85%, at least 90%, at least 95%, at least 97%, at least 98% or at least 99% identity to amino acids 19-604 of SEQ ID No. 1. The second glucose oxidase may suitably be a fungal, such as a filamentous fungal, or Aspergillus glucose oxidase. In one embodiment, a dough is prepared from a flour comprising a) 1 to 50 ppm of a Penicillium glucose oxidase and b) 1 to 200 ppm of a second glucose oxidase. A dough comprising a Penicillium glucose oxidase, for example a Penicillium glucose oxidase with an amino acid sequence which shows at least 75%, at least 80%, at least 85%, at least 90%, at least 95%, at least 97%, at least 98% or at least 99% identity to amino acids 19-604 of SEQ ID No. 1, and a second glucose oxidase is also encompassed by the present invention.

In the context of the present invention, the term ‘dough’ is defined as a mixture of flour and other ingredients. In one embodiment, the dough is firm enough to knead or roll. The dough may be fresh prepared or par-baked. Dough is made using at least one dough ingredient. The at least one dough ingredient may be selected from the group consisting of (cereal) flour, a lecithin source including egg, water, salt, sugar, flavours, a fat source including butter, margarine, oil and shortening, baker's yeast, chemical leavening systems such as a combination of an acid (generating compound) and bicarbonate, a protein source including milk, soy flour, non-chemical oxidants (including ascorbic acid), a reducing agent (including L-cysteine), an emulsifier (including mono- and di glycerides, monoglycerides such as glycerol monostearate (GMS), sodium stearoyl lactylate (SSL), calcium stearoyl lactylate (CSL), polyglycerol esters of fatty acids (PGE) and diacetyl tartaric acid esters of mono- and diglycerides (DATEM), propylene glycerol monostearate and lecithin), a gum (including guar gum and xanthan gum), a flavour, an acids (including citric acid, propionic acid), a starch, a modified starch, gluten, a humectant (including glycerol) and a preservative.

Dough is made using dough ingredients, which include without limitation (cereal) flour, a lecithin source including egg, water, salt, sugar, flavours, a fat source including butter, margarine, oil and shortening, baker's yeast, chemical leavening systems such as a combination of an acid (generating compound) and bicarbonate, a protein source including milk, soy flour, non-chemical oxidants (including ascorbic acid, bromate and azodicarbonamide (ADA), reducing agents (including L-cysteine), emulsifiers (including mono/di glycerides, monoglycerides such as glycerol monostearate (GMS), sodium stearoyl lactylate (SSL), calcium stearoyl lactylate (CSL), polyglycerol esters of fatty acids (PGE) and diacetyl tartaric acid esters of mono- and diglycerides (DATEM), gums (including guar gum and xanthan gum), flavours, acids (including citric acid, propionic acid), starch, modified starch, gluten, humectants (including glycerol) and preservatives.

Dough is usually made from basic dough ingredients including (cereal) flour, such as wheat flour or rice flour, water and optionally salt. Cereals include maize, rice, wheat, barley, sorghum, millet, oats, rye, triticale, buckwheat, quinoa, spelt, einkorn, emmer, durum and kamut.

For leavened products, primarily baker's yeast is used next to chemical leavening systems such as a combination of an acid or acid generating compound and bicarbonate.

In the context of the present invention, the term dough includes a batter. A batter is a semi-liquid mixture, being thin enough to drop or pour from a spoon, of one or more flours combined with liquids such as water, milk or eggs used to prepare various foods, including cake. The dough may be made using a mix including a cake mix, a biscuit mix, a brownie mix, a bread mix, a pancake mix and a crepe mix.

In one embodiment, a composition according to the invention is added to a dough. The composition according to the invention may be provided in a dry form, to allow easy addition to the dough, but liquid forms are also possible. A liquid form includes without limitation an emulsion, a suspension and a solution. Irrespective of the formulation of the enzyme composition, any additive or additives known to be useful in the art to improve and/or maintain the enzyme's activity, the quality of the dough and/or the baked product may be applied.

Yeast, enzymes and optionally additives are generally added separately from each other to the dough. Enzymes may be added in a dry, e.g. granulated form, in a liquid form or in the form of a paste. Additives are in most cases added in powder form. Suitable additives include chemical or non-chemical oxidants, including ascorbic acid, bromate and azodicarbonamide (ADA); reducing agents, including L-cysteine; emulsifiers, including lecithin and mono and diglycerides, such as glycerol monostearate (GMS), sodium stearoyl lactylate (SSL), calcium stearoyl lactylate (CSL), polyglycerol esters of fatty acids (PGE) and diacetyl tartaric acid esters of mono- and diglycerides (DATEM); gums, including guar gum and xanthan gum; flavours, acids, including citric acid and propionic acid; starch, including modified starch; gluten; humectants, including glycerol; and preservatives. A suitable additive includes propylene glycerol monostearate (PGMS).

The preparation of a dough from the dough ingredients is well known in the art and includes mixing of said ingredients and optionally one or more moulding and fermentation steps. In another aspect, the present invention relates to a method for improving a dough. The method comprises combining a pre-mix or flour comprising a Penicillium glucose oxidase and a second glucose oxidase with at least one dough ingredient and is also encompassed by the present invention.

The preparation of baked products from such doughs is also well known in the art and may comprise moulding and shaping and further fermentation of the dough followed by baking at required temperatures and baking times. In one embodiment the invention provides a method to prepare a baked product comprising the step of baking a dough comprising a Penicillium glucose oxidase and a second glucose oxidase, such as a fungal, such as a filamentous fungal, or Aspergillus glucose oxidase. The baking of the dough to produce a baked product may be performed using methods well known in the art. The invention also provides a baked product obtainable according to this method. In one embodiment of the invention, the baked product according to the invention is bread or cake.

Examples of baked products, whether of a white, brown or whole-meal type, which may be advantageously produced by the present invention include bread (in particular white, whole-meal or rye bread), typically in the form of loaves or rolls, French baguette-type bread, pastries, croissants, brioche, panettone, pasta, noodles (boiled or (stir-)fried), pita bread and other flat breads, tortillas, tacos, cakes, pancakes, cookies in particular biscuits, doughnuts, including yeasted doughnuts, bagels, pie crusts, steamed bread, crisp bread, brownies, sheet cakes, snack foods (e.g., pretzels, tortilla chips, fabricated snacks, fabricated potato crisps). The term baked product includes, bread containing from 2 to 30 wt % sugar, fruit containing bread, breakfast cereals, cereal bars, eggless cake, soft rolls and gluten-free bread. Gluten free bread herein and herein after is bread than contains at most 20 ppm gluten. Several grains and starch sources are considered acceptable for a gluten-free diet. Frequently used sources are potatoes, rice and tapioca (derived from cassava). Baked product includes without limitation tin bread, loaves of bread, twists, buns, such as hamburger buns or steamed buns, chapati, rusk, dried steam bun slice, bread crumb, matzos, focaccia, melba toast, zwieback, croutons, soft pretzels, soft and hard bread, bread sticks, yeast leavened and chemically-leavened bread, laminated dough products such as Danish pastry, croissants or puff pastry products, muffins, Danish bagels, confectionery coatings, crackers, wafers, pizza crusts, tortillas, pasta products, crepes, waffles and par-baked products. An example of a par-baked product includes, without limitation, partially baked bread that is completed at point of sale or consumption with a short second baking process.

The bread may be white or brown pan bread and may for example be manufactured using a so called American style Sponge and Dough method or an American style Direct method.

The term tortilla herein includes corn tortilla and wheat tortilla. A corn tortilla is a type of thin, flat bread, usually unleavened made from finely ground maize (usually called “corn” in the United States). A flour tortilla is a type of thin, flat bread, usually unleavened, made from finely ground wheat flour. The term tortilla further includes a similar bread from South America called arepa, though arepas are typically much thicker than tortillas. The term tortilla further includes a laobing, a pizza-shaped thick “pancake” from China and an Indian Roti, which is made essentially from wheat flour. A tortilla usually has a round or oval shape and may vary in diameter from about 6 to over 30 cm.

Baked products obtained by using a dough prepared according to the invention are also encompassed by the present invention. All the embodiments which were mentioned above for the flour, with all the preferences mentioned above, also apply to doughs and baked products according to the invention.

In yet another aspect, compositions according to the invention may be used as improving agents, also referred to as bread improvers or dough improvers, which are combined with flour to improve functionalities of the bread, dough or of the baked product made from the dough. The improvement is in comparison to a dough which does not contain a bread or dough improver according to the invention and may be reflected in any functionality of the bread, dough or baked product from the dough, such as increased strength of the dough, increased viscoelasticity of the dough, increased stability of the dough, reduced stickiness of the dough, improved extensibility of the dough, improved machinability of the dough, increased volume of the baked product, improved flavour of the baked product, improved crumb structure of the baked product, improved crumb softness of the baked product, reduced blistering of the baked product, improved crispiness, improved resilience both initial and in particular after storage, reduced hardness after storage or improved anti-staling properties of the baked product.

The term “increased strength of the dough” is defined herein as the property of a dough that has generally more viscoelastic properties and/or requires more work input to mould and shape.

The term “increased viscoelasticity of the dough” is defined herein as the property of a dough which has a higher tendency to regain its original shape after being subjected to a certain physical strain.

The term “increased stability of the dough” is defined herein as the property of a dough that is less susceptible to forming faults as a consequence of mechanical abuse thus better maintaining its shape and volume and is evaluated by the ratio of height: width of a cross section of a loaf after normal and/or extended proof.

The term “reduced stickiness of the dough” is defined herein as the property of a dough that has less tendency to adhere to surfaces, e.g., in the dough production machinery, and is either evaluated empirically by the skilled test baker or measured by a suitable system known in the art, such as Warburtons dough stickiness system

The term “improved extensibility of the dough” is defined herein as the property of a dough that can be subjected to increased strain or stretching without rupture.

The term “improved machinability of the dough” is defined herein as the property of a dough that is generally less sticky and/or more firm and/or more elastic. Consequently there is less fouling of plant equipment and a reduced need for cleaning.

The term “improved crumb structure of the baked product” is defined herein as the property of a baked product with finer cells and/or thinner cell walls in the crumb and/or more uniform/homogenous distribution of cells in the crumb and is usually evaluated visually by the baker or by digital image analysis as known in the art (eg. C-cell, Calibre Control International Ltd, Appleton, Warrington, UK).

The term “improved softness of the baked product” is the opposite of “hardness” and is defined herein as the property of a baked product that is more easily compressed and is evaluated either empirically by the skilled test baker or measured by the use of a texture analyzer known in the art.

The term “reduced blistering of the baked product” is defined herein as a visually determined reduction of blistering on the crust of the baked bread.

The term “improved crispiness” is defined herein as the property of a baked product to give a crispier sensation than a reference product as known in the art, as well as to maintain this crispier perception for a longer time than a reference product. This property can be quantified by measuring a force versus distance curve at a fixed speed in a compression experiment using e.g. a texture analyzer TA-XT Plus (Stable Micro Systems Ltd, Surrey, UK), and obtaining physical parameters from this compression curve, viz. (i) force of the first peak, (ii) distance of the first peak, (iii) the initial slope, (iv) the force of the highest peak, (v) the area under the graph and (vi) the amount of fracture events (force drops larger than a certain preset value). Indications of improved crispness are a higher force of the first peak, a shorter distance of the first peak, a higher initial slope, a higher force of the highest peak, higher area under the graph and a larger number of fracture events. A crispier product should score statistically significantly better on at least two of these parameters as compared to a reference product. In the art, “crispiness” is also referred to as crispness, crunchiness or crustiness, meaning a material with a crispy, crunchy or crusty fracture behaviour.

The term “improved anti-staling properties of the baked product” is defined herein as the properties of a baked product that have a reduced rate of deterioration of quality parameters, e.g. reduced hardness after storage and/or decreased loss of resilience after storage. Anti-staling properties may be demonstrated by a reduced hardness after storage of the baked product. The enzyme composition according to the invention or the pre-mix according to the invention may result in reduced hardness, e.g. in a baked product that is more easily compressed. The hardness of the baked product may be evaluated either empirically by the skilled test baker or measured by the use of a texture analyzer known in the art. The hardness measured within 24 hours after baking is called initial hardness. The hardness measured 24 hours or more after baking is called hardness after storage, and is also a measure for determining shelf life. In case the initial hardness has reduced, it has improved. In case the hardness after storage has reduced, it has improved. Resilience of the baked product is preferably measured by the use of a texture analyzer known in the art. The resilience measured within 24 hours after baking is called initial resilience. The resilience measured 24 hours or more after baking is called resilience after storage, and is also a measure for determining shelf life. Freshly baked product typically gives crumb of high initial resilience but resilience is lost over shelf-life. Improved anti-staling properties may be demonstrated by a reduced loss of resilience over storage.

In an aspect of the invention, a use of the invention is a use of a composition comprising a combination of glucose oxidases for improving the stability of a dough. In an aspect of the invention, a use of the invention is a use of a composition comprising a combination of glucose oxidases for improving the stability of a dough, wherein the combination of glucose oxidases comprises a Penicillium glucose oxidase having an amino acid sequence having at least 75% identity to amino acids 19 to 604 of SEQ ID NO. 1 and a second glucose oxidase obtainable from an Aspergillus. Preferably the second glucose oxidase obtainable from an Aspergillus, is an Aspergillus niger glucose oxidase.

In an aspect of the invention, a use of the invention is a use of a composition comprising a combination of glucose oxidases for improving the volume of a baked product.

In an aspect of the invention, a use of the invention is a use of a composition comprising a combination of glucose oxidases for improving the volume of a baked product, wherein the combination of glucose oxidases comprises a Penicillium glucose oxidase having an amino acid sequence having at least 75% identity to amino acids 19 to 604 of SEQ ID NO. 1 and a second glucose oxidase obtainable from an Aspergillus. Preferably the second glucose oxidase obtainable from an Aspergillus, is an Aspergillus niger glucose oxidase.

In an aspect of the invention, a use of the invention is a use of a composition comprising a combination of glucose oxidases for improving the crumb structure of a baked product. In an aspect of the invention, a use of the invention is a use of a composition comprising a combination of glucose oxidases for improving the crumb structure of a baked product, wherein the combination of glucose oxidases comprises a Penicillium glucose oxidase having an amino acid sequence having at least 75% identity to amino acids 19 to 604 of SEQ ID NO. 1 and a second glucose oxidase obtainable from an Aspergillus. Preferably the second glucose oxidase obtainable from an Aspergillus, is an Aspergillus niger glucose oxidase.

In an aspect of the invention, a use of the invention is a use of a composition comprising a combination of glucose oxidases for improving the stability of a dough and/or the volume of a baked product and/or the crumb structure of a baked product.

In an aspect of the invention, a use of the invention is a use of a composition comprising a combination of glucose oxidases for improving the stability of a dough and/or the volume of a baked product and/or the crumb structure of a baked product, wherein the combination of glucose oxidases comprises a Penicillium glucose oxidase having an amino acid sequence having at least 75% identity to amino acids 19 to 604 of SEQ ID NO. 1 and a second glucose oxidase obtainable from an Aspergillus. Preferably the second glucose oxidase obtainable from an Aspergillus, is an Aspergillus niger glucose oxidase.

In an aspect of the invention, a use of the invention is a use of a composition comprising a combination of glucose oxidases for improving the stability of a dough and/or the volume of a baked product and/or the crumb structure of a baked product, wherein the combination of glucose oxidases comprises a Penicillium glucose oxidase having an amino acid sequence having at least 75% identity to amino acids 19 to 604 of SEQ ID NO. 1 and a second glucose oxidase, wherein the second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3. In an aspect the second glucose oxidase is an Aspergillus glucose oxidase comprising an amino acid sequence as set out in SEQ ID NO: 3.

In an aspect the invention relates to a dough comprising a Penicillium glucose oxidase having an amino acid sequence having at least 75% identity to amino acids 19 to 604 of SEQ ID NO. 1 and a second glucose oxidase, wherein the second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3. In an aspect the dough comprises as the second glucose oxidase an Aspergillus glucose oxidase comprising an amino acid sequence as set out in SEQ ID NO: 3.

The invention further relates to dough comprising a Penicillium glucose oxidase comprising an amino acid sequence as set out in amino acids 19 to 604 of SEQ ID NO. 1 and a second glucose oxidase, wherein the second glucose oxidase is an Aspergillus glucose oxidase comprising an amino acid sequence having at least 85% identity to the amino acid sequence as set out in SEQ ID NO: 3.

The invention further relates to dough comprising a Penicillium glucose oxidase comprising an amino acid sequence as set out in amino acids 19 to 604 of SEQ ID NO. 1 and a second glucose oxidase, wherein the second glucose oxidase is an Aspergillus glucose oxidase comprising an amino acid sequence having at least 90% identity to the amino acid sequence as set out in SEQ ID NO: 3.

The invention further relates to dough comprising a Penicillium glucose oxidase comprising an amino acid sequence as set out in amino acids 19 to 604 of SEQ ID NO. 1 and a second glucose oxidase, wherein the second glucose oxidase is an Aspergillus glucose oxidase comprising an amino acid sequence having at least 95% identity to the amino acid sequence as set out in SEQ ID NO: 3.

In an aspect the dough according to the invention comprises by weight of flour

a) 1 to 50 ppm of the Penicillium glucose oxidase; and
b) 1 to 200 ppm of the second glucose oxidase.

In an aspect the dough according to the invention comprises by weight of flour

a) 1 to 50 ppm of the Penicillium glucose oxidase; and
b) 1 to 200 ppm of the second glucose oxidase, wherein the Penicillium glucose oxidase comprises an amino acid sequence as set out in amino acids 19 to 604 of SEQ ID NO. 1 and wherein the second glucose oxidase is an Aspergillus glucose oxidase comprising an amino acid sequence having at least 95% identity to the amino acid sequence as set out in SEQ ID NO: 3.

The invention also relates to a method for increasing dough stability comprising the step of combining a Penicillium glucose oxidase and a second glucose oxidase with at least one dough ingredient.

In an aspect of the method according to the invention for increasing dough stability the second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3.

In an aspect of the method according to the invention for increasing dough stability the second glucose oxidase is an Aspergillus glucose oxidase comprising an amino acid sequence as set out in the amino acid sequence SEQ ID NO: 3.

In an aspect of the method according to the invention for increasing dough stability the Penicillium glucose oxidase comprises an amino acid sequence having at least 75% identity to amino acids 19 to 604 of SEQ ID NO. 1.

In an aspect of the method according to the invention for increasing dough stability the Penicillium glucose oxidase comprises an amino acid sequence as set out in amino acids 19 to 604 of SEQ ID NO. 1.

In an aspect of the method according to the invention for increasing dough stability the Penicillium glucose oxidase comprises an amino acid sequence as set out in amino acids 19 to 604 of SEQ ID NO. 1 and a second glucose oxidase, wherein the second glucose oxidase is an Aspergillus glucose oxidase comprising an amino acid sequence having at least 85% identity to the amino acid sequence as set out in SEQ ID NO: 3.

In an aspect of the method according to the invention for increasing dough stability the Penicillium glucose oxidase comprises an amino acid sequence as set out in amino acids 19 to 604 of SEQ ID NO. 1 and a second glucose oxidase, wherein the second glucose oxidase is an Aspergillus glucose oxidase comprising an amino acid sequence having at least 90% identity to the amino acid sequence as set out in SEQ ID NO: 3.

In an aspect of the method according to the invention for increasing dough stability the Penicillium glucose oxidase comprises an amino acid sequence as set out in amino acids 19 to 604 of SEQ ID NO. 1 and a second glucose oxidase, wherein the second glucose oxidase is an Aspergillus glucose oxidase comprising an amino acid sequence having at least 95% identity to the amino acid sequence as set out in SEQ ID NO: 3.

In an aspect the method for increasing dough stability comprises the step of combining at least one dough ingredient, a Penicillium glucose oxidase comprising an amino acid sequence as set out in amino acids 19 to 604 of SEQ ID NO. 1 and a second glucose oxidase, preferably wherein the second glucose oxidase is an Aspergillus glucose oxidase comprising an amino acid sequence having at least 85% identity to the amino acid sequence as set out in SEQ ID NO: 3.

In an aspect the method for increasing dough stability comprises the step of combining at least one dough ingredient, a Penicillium glucose oxidase comprising an amino acid sequence as set out in amino acids 19 to 604 of SEQ ID NO. 1 and a second glucose oxidase, preferably wherein the second glucose oxidase is an Aspergillus glucose oxidase comprising an amino acid sequence having at least 90% identity to the amino acid sequence as set out in SEQ ID NO: 3.

In an aspect the method for increasing dough stability comprises the step of combining at least one dough ingredient, a Penicillium glucose oxidase comprising an amino acid sequence as set out in amino acids 19 to 604 of SEQ ID NO. 1 and a second glucose oxidase, preferably wherein the second glucose oxidase is an Aspergillus glucose oxidase comprising an amino acid sequence having at least 95% identity to the amino acid sequence as set out in SEQ ID NO: 3.

In an aspect the method for increasing dough stability comprises the step of combining at least one dough ingredient, a Penicillium glucose oxidase comprising an amino acid sequence as set out in amino acids 19 to 604 of SEQ ID NO. 1 and a second glucose oxidase, preferably wherein the second glucose oxidase is an Aspergillus glucose oxidase comprising an amino acid sequence having at least 96% identity to the amino acid sequence as set out in SEQ ID NO: 3.

In an aspect the method for increasing dough stability comprises the step of combining at least one dough ingredient, a Penicillium glucose oxidase comprising an amino acid sequence as set out in amino acids 19 to 604 of SEQ ID NO. 1 and a second glucose oxidase, preferably wherein the second glucose oxidase is an Aspergillus glucose oxidase comprising an amino acid sequence having at least 97% identity to the amino acid sequence as set out in SEQ ID NO: 3.

In an aspect of the method according to the invention for increasing dough stability the Penicillium glucose oxidase is used in an amount of from 1 ppm up to and including 50 ppm based on weight of flour and wherein the Penicillium glucose oxidase has an activity in the range of 2500-4000 glucose oxidase units/gram enzyme.

In aspect 1 of the invention, a use of the invention is a use of a composition comprising a combination of glucose oxidases for improving the stability, volume or crumb structure of a baked product.

In aspect 2 of the invention, a use of the invention is a use according to aspect 1, wherein the composition comprises a Penicillium glucose oxidase and a second glucose oxidase.

In aspect 3 of the invention, a use of the invention is a use according to aspect 2, wherein the second glucose oxidase is obtainable from a filamentous fungus.

In aspect 4 of the invention, a use of the invention is a use according to aspect 2 or 3, wherein the second glucose oxidase is obtainable from an Aspergillus.

In aspect 5 of the invention, a use of the invention is a use according to any one of aspects 2 to 4, wherein

the Penicillium glucose oxidase has an amino acid sequence having at least 75% identity to amino acids 19 to 604 of SEQ ID NO. 1.

In aspect 6 of the invention, a method of the invention is a method for improving flour, which method comprises adding to the flour by weight of flour (i) 1 to 50 ppm of a Penicillium glucose oxidase and (ii) 1-200 ppm of a second glucose oxidase

In aspect 7 of the invention, a method of the invention is a method according to aspect 6, wherein the second glucose oxidase is an Aspergillus glucose oxidase.

In aspect 8 of the invention, a pre-mix or flour of the invention is a pre-mix or flour comprising a combination of a Penicillium glucose oxidase and a second glucose oxidase.

In aspect 9 of the invention, a flour of the invention is a flour according to aspect 8 comprising by weight of flour

a) 1 to 50 ppm of a Penicillium glucose oxidase; and
b) 1 to 200 ppm of a second glucose oxidase

In aspect 10 of the invention, a pre-mix or flour of the invention is a pre-mix according to aspect 8 or a flour according to aspect 8 or 9, wherein the second glucose oxidase is an Aspergillus glucose oxidase.

In aspect 11 of the invention, a method of the invention is a method a method for preparing a dough comprising combining a pre-mix according to aspect 8 or 10, or a flour according to any one of aspects 8 to 10 with at least one dough ingredient.

In aspect 12 of the invention, a dough of the invention is dough prepared from a pre-mix according to aspect 8 or 10, or a flour according to any one of aspects 8 to 10.

In aspect 13 of the invention, a method of the invention is a method for preparing a baked product comprising the step of baking the dough according to aspect 12.

In aspect 14 of the invention, a baked product of the invention is a baked product prepared from a pre-mix according to aspect 8 or 10, or from a flour according any one of aspects 8 to 10 or from a dough according to aspect 12.

In aspect 15 of the invention, a method according to the invention is a method for increasing dough stability comprising the step of combining Penicillium glucose oxidase, a second glucose oxidase and at least one dough ingredient.

In aspect 16 of the invention, a method according to the invention is a method according to aspect 15, wherein the second glucose oxidase is an Aspergillus glucose oxidase comprising an amino acid sequence having at least 85% identity, or at least 90% identity, or at least 95% identity, or at least 96% identity, or at least 97% identity, or at least 98% identity, or at least 99% identity, to the amino acid sequence as set out in SEQ ID NO: 3.

In aspect 17 of the invention, a method according to the invention is a method according to aspect 16, wherein the second glucose oxidase is an Aspergillus glucose oxidase comprising an amino acid sequence as set out in the amino acid sequence SEQ ID NO: 3.

In aspect 18, a method according to the invention is the method according to any one of aspects 15 to 17, wherein the Penicillium glucose oxidase comprises an amino acid sequence having at least 75% identity to amino acids 19-604 of SEQ ID No. 1.

In aspect 18, a method according to the invention is the method according to any one of aspects 15 to 17, wherein the Penicillium glucose oxidase comprises an amino acid sequence as set out in amino acids 19-604 of SEQ ID No. 1.

In aspect 19, a method according to the invention is the method according to any one of aspects 15 to 19, wherein the Penicillium glucose oxidase is used in an amount of from 1 ppm up to and including 50 ppm based on weight of flour and wherein the Penicillium glucose oxidase has an activity in the range of 2500-4000 glucose oxidase units/gram enzyme.

### EXAMPLES

### Materials and Methods

### Flour Corrector

The flour corrector used was a composition comprising 30 ppm ascorbic acid (from DSM Nutritional Products, Switzerland), 2 ppm Bakezyme® P500 (fungal alpha-amylase from DSM, The Netherlands), 15 ppm Bakezyme® HSP6000 (fungal hemicellulase from DSM, The Netherlands) and Kolibri flour (Meneba, the Netherlands) as filling material.

### Glucose Oxidases

Penicillium glucose oxidase was Penicillium chrysogenum glucose oxidase with a protein sequence as depicted in SEQ ID No.1 prepared by transformation of an Aspergillus with a construct comprising a cDNA sequence as depicted in SEQ ID No. 2.

The Penicillium glucose oxidase used was Penicillium chrysogenum glucose oxidase with a protein sequence as depicted in SEQ ID No.1 prepared by transformation of an Aspergillus with a construct comprising a cDNA sequence as depicted in SEQ ID No. 2 and subsequent expression of the enzyme.

BakeZyme® G010.000 BG, (Aspergillus tubingensis glucose oxidase, from DSM Food Specialties, the Netherland.

### Determination of Glucose Oxidase Activity

Glucose oxidase activity was determined in an assay in which gluconic acid formed is titrated. Thereto, 1 ml of diluted glucose oxidase was added to 25 ml of preheated 30 g/I glucose monohydrate solution at 35 degrees C. Sample dilutions and substrate were prepared in 50 mM HAc buffer at pH 5.1, containing 50 mM NaCl. After 15 minutes incubation at 35 degrees C., the reaction was terminated by the addition of 10 ml 0.1 N NaOH, at the same time neutralizing the gluconic acid formed. Excess NaOH was titrated with 0.05 M HCl. The difference in HCl consumption between a sample and blank run is a measure for the amount of glucose oxidase activity. One glucose oxidase unit is defined as the amount of enzyme needed to oxidize 3 mg of glucose to gluconic acid under conditions of the assay.

Activity of Penicillium glucose oxidase used was 3300 glucose oxidase units/gram enzyme. ppm means mg/kg, e.g. 20 ppm means 20 mg of the indicated product per kg flour.

### Stressful Shock Test

The stressful shock test is performed to simulate the stress that a proofed dough can be submitted in a bakery facility, like transportation in hacks or conveyor belts. The test consists in putting a pan with a proofed dough piece over two supports that are pulled apart letting the pan drop from 70 mm on a table. This step is done twice. A proofed dough with lack of strength will collapse and thus show a decrease in volume.

### Wheat Bread Flour—USA

Wheat bread flour USA is flour from spring and winter wheat to produce a quality patent flour. The wheat bread flour used was Honeyville's Golden Loaf Bread Flour from Inter-County Bakers, Inc. Lindenhurst, N.Y.

### Example 1 Baking Performance of a Combination of Two Fungal Glucose Oxidases

The baking performance of a combination of Penicillium glucose oxidase with another glucose oxidase was tested in floor baked bread. The other glucose oxidase was Aspergillus glucose oxidase as present in Bakezyme G010.000 BG (DSM, the Netherlands).

A bread dough was prepared by mixing the ingredients listed in Table 1 together with the glucose oxidase or a glucose oxidase combination according to Table 2 first column in a Diosna SP-12 mixer, 400 turns, at a frequency of 25 Hz and thereafter 72 Wh at a frequency of 50 Hz, to a final dough temperature of 28° C.

TABLE 1
Basic bread recipe

| | | % based | |
|---|---|---|---|
| | | on flour | |
| Ingredient | grams | weight | Type |
| Flour | 1600 | | Kolibri, Meneba, the Netherlands |
| Flour | 400 | | Ibis, Meneba, the Netherlands |
| Salt | 36 | 1.8 | Suprasel, Akzo Nobel, the |
| | | | Netherlands |
| Fresh yeast | 50 | 2.5 | Koningsgist, AB Mauri, the |
| | | | Netherlands |
| Flour corrector | 10 | 0.5 | See materials & methods |
| Water | 1240 | 62 | +/−1% |

The dough was divided in 6 pieces of 350 g, rounded and proofed in the bench proof cabinet for 20 minutes at 28° C. and 90% relative humidity. Then, the dough pieces were moulded using a Bertrand baguette moulder and placed on greased baking trays after that, the dough pieces were proofed in a Wachtel Octopus proof cabinet for 75 minutes at 32° C. with a relative humidity of 88%. The fully proofed dough pieces were cut twice, diagonally on top of the dough piece, using a razor blade knife and placed in a Wachtel Comet rotation oven set at 245° C. top heat and 235° C. floor heat with initial steam addition and baked for 5 minutes. After that, the temperature was decreased to 225° C. top heat and 235° C. floor heat for another 20 minutes

After baking, the oven was unloaded, the breads were taken off the baking trays and placed on a rack to cool for at least one hour at ambient temperature, which was typically between 20 and 25° C. After 1-2 hours cooling, the breads were assessed on volume, shape, softness and structure.

After cooling down to room temperature, the volumes of the loaves were determined by an automated bread volume analyser (BVM-3, TexVol Instruments). The loaf volume of the control bread is defined as 100%. Results are shown in Table 2, which shows the average value of four loaves for each recipe. The control refers to a loaf of bread prepared from the ingredients in Table 1, i.e. to which no Penicillium glucose oxidase or Aspergillus glucose oxidase was added.

TABLE 2
Average volume of four loaves

| | Relative Volume (%) |
|---|---|
| Control | 100 |
| 20 ppm Bakezyme GO10.000 | 101 |
| BG | |
| 20 ppm Penicillium glucose | 103 |
| oxidase | |
| 8 ppm Bakezyme GO10.000 | 107 |
| BG* and 12 ppm Penicillium | |
| glucose oxidase | |

*Aspergillus niger glucose oxidase, from DSM Food Specialties, the Netherlands

These results show that the two glucose oxidase are working synergistically (volume increase 7%, instead of 4%), creating improved stability, translated in increased volume of the final bread.

The crumb structure was examined and it was clearly visible that bread containing Penicillium glucose oxidase showed a finer crumb structure than breads without this glucose oxidase. The crust opening was also improved.

The consistency, body, development, extensibility, elasticity and stickiness of the dough were evaluated by an experienced baker. Dough containing a combination of 8 ppm Bakezyme G010.000 BG and 12 ppm Penicillium glucose oxidase was considered to have superior dough handling properties.

In conclusion, a dough containing a combination of Penicillium glucose oxidase with a second glucose oxidase displayed improved handling properties and resulted in a baked product with improved volume and crumb structure.

### Example 2 Baking Experiments with and without Shock

In this experiment the baking performance of Penicillium glucose oxidase with another glucose oxidase was tested in American Style open top tin bread using a direct process. Aspergillus glucose oxidase as present in Bakezyme G010.000 BG (DSM, the Netherlands) was used as the other glucose oxidase.

The ingredients listed in Table 3 were mixed in a Hobart A-120 mixer using a McDuffy bowl and hook agitator for two minutes at speed one, thereafter for six minutes at speed two, to optimum gluten development, to a final dough temperature of 25° C. to 27° C. The fully mixed dough was allowed to rest, covered under plastic, for two minutes at room temperature.

TABLE 3

| Ingredients | amounts in grams |
|---|---|
| Wheat Bread Flour—USA | 1000 |
| Water | 660 |
| Yeast instant dry | 20 |
| Sugar | 40 |
| Shortening (soy bean oil) | 40 |
| Salt | 20 |

All ingredients were supplied by Inter-County Bakers, Inc. Lindenhurst, New York.

The dough was divided in pieces of 450 g, rounded and allowed to rest for two minutes at room temperature. Afterwards the dough pieces were moulded using a Unic moulder (top 6.5/bottom 6) and the moulded loaves were placed into bread pans and placed in a proofing cabinet at 38° C., at relative humidity of 85% for 85 minutes. Part of the fully proofed dough pieces were subjected to the stressful shock test as described in Materials & Methods. Then, dough pieces with and without shock test were placed in a BeCOM revolving oven and baked in 24 minutes at 205° C. Thereafter, the breads were taken out of the oven, de-panned and placed on a rack to cool for at least 1 hour at ambient temperature, which was typically between 20 and 25° C. After 1-2 hours cooling, the breads were assessed on weight and volume.

After cooling down to room temperature the weights of the loaves were determined using a Mettler Toledo scale with a precision of 0.01 gram. The volumes of the loaves were determined using a Loaf Volumeter (1 Pound Volumeter—National Cereal Chemistry Equipment). Results are shown in Table 4

TABLE 4

| | Relative | Relative |
|---|---|---|
| | Volume (%) | Volume (%) |
| | non shock | shock |
| Control | 100 | 100 |
| 10 ppm Bakezyme GO10.000 BG* | 106 | 119 |
| 10 ppm Penicillium glucose oxidase | 102 | 117 |
| 5 ppm Bakezyme G010.000 BG and | 105 | 121 |
| 5 ppm Penicillium glucose oxidase | | |

*Aspergillus niger glucose oxidase, from DSM Food Specialties, the Netherlands

The non-shock test results show that the volume of the bread prepared using a combination of glucose oxidases (5 ppm each) showed a volume increase (5%).

The shock test results show that the combination of 5 ppm Aspergillus glucose oxidase and 5 ppm Penicillium glucose oxidase creates synergy in comparison to 10 ppm Aspergillus glucose oxidase or 10 ppm Penicillium glucose oxidase under stressful conditions such as in a shock test, creating improved stability, translated in increased volume of the final bread.

Crumb structure evaluation showed that bread containing Penicillium glucose oxidase resulted in bread with a finer crumb structure.

These results illustrate that a dough containing a combination of Penicillium glucose oxidase with another glucose oxidase results in a baked product with improved stability, translated in increased volume of the final bread and improved crumb structure.

### Example 3 Baking Performance of a Combination of Two Fungal Glucose Oxidases

The baking performance of a combination of Penicillium glucose oxidase with another glucose oxidase was tested in floor baked bread. The other glucose oxidase was Aspergillus glucose oxidase as present in Bakezyme G010.000 BG (DSM, the Netherlands).

A bread dough was prepared by mixing the ingredients listed in Table 5 together with the glucose oxidase or a glucose oxidase combination according to Table 6 first column in a Diosna SP-12 mixer, 400 turns, at a frequency of 25 Hz and thereafter 72 Wh at a frequency of 50 Hz, to a final dough temperature of 28° C.

TABLE 5
Basic bread recipe

| | | % based | |
|---|---|---|---|
| | | on flour | |
| Ingredient | grams | weight | Type |
| Flour | 1600 | | Kolibri, Meneba, the Netherlands |
| Flour | 400 | | Ibis, Meneba, the Netherlands |
| Salt | 36 | 1.8 | Suprasel, Akzo Nobel, the |
| | | | Netherlands |
| Fresh yeast | 50 | 2.5 | Koningsgist, AB Mauri, the |
| | | | Netherlands |
| Flour corrector | 10 | 0.5 | See materials & methods |
| Water | 1240 | 62 | +/−1% |

The dough was divided in 6 pieces of 350 g, rounded and proofed in the bench proof cabinet for 20 minutes at 28° C. and 90% relative humidity. Then, the dough pieces were moulded using a Bertrand baguette moulder and placed on greased baking trays after that, the dough pieces were proofed in a Wachtel Octopus proof cabinet for 75 minutes at 32° C. with a relative humidity of 88%. The fully proofed dough pieces were cut twice, diagonally on top of the dough piece, using a razor blade knife and placed in a Wachtel Comet rotation oven set at 245° C. top heat and 235° C. floor heat with initial steam addition and baked for 5 minutes. After that, the temperature was decreased to 225° C. top heat and 235° C. floor heat for another 20 minutes

After baking, the oven was unloaded, the breads were taken off the baking trays and placed on a rack to cool for at least one hour at ambient temperature, which was typically between 20 and 25° C. After 1-2 hours cooling, the breads were assessed on volume, shape, softness and structure.

After cooling down to room temperature, the volumes of the loaves were determined by an automated bread volume analyser (BVM-3, TexVol Instruments). The loaf volume of the control bread is defined as 100%. Results are shown in Table 5, which shows the average value of four loaves for each recipe. The control refers to a loaf of bread prepared from the ingredients in Table 4, i.e. to which no Penicillium glucose oxidase or Aspergillus glucose oxidase was added.

TABLE 6
Average volume of four loaves

| | Relative Volume (%) |
|---|---|
| Control | 100 |
| 20 ppm Bakezyme GO10.000 | 101 |
| BG | |
| 20 ppm Penicillium glucose | 103 |
| oxidase | |
| 8 ppm Bakezyme GO10.000 | 107 |
| BG* and 12 ppm Penicillium | |
| glucose oxidase | |

*BakeZyme ® GO10.000 BG, (Aspergillus glucose oxidase as set out in SEQ ID No.3., from DSM Food Specialties, the Netherlands).

These results show that the two glucose oxidase are working synergistically (volume increase 7%, instead of 4%), creating improved stability, translated in increased volume of the final bread.

The crumb structure was examined and it was clearly visible that bread containing Penicillium glucose oxidase showed a finer crumb structure than breads without this glucose oxidase. The crust opening was also improved.

The consistency, body, development, extensibility, elasticity and stickiness of the dough were evaluated by an experienced baker. Dough containing a combination of 8 ppm Bakezyme G010.000 BG and 12 ppm Penicillium glucose oxidase was considered to have superior dough handling properties.

In conclusion, a dough containing a combination of Penicillium glucose oxidase with a second glucose oxidase displayed improved handling properties and resulted in a baked product with improved volume and crumb structure.

### Example 4 Baking Experiments with and without Shock

In this experiment the baking performance of Penicillium glucose oxidase with another glucose oxidase was tested in American Style open top tin bread using a direct process. Aspergillus glucose oxidase as present in Bakezyme G010.000 BG (DSM, the Netherlands) was used as the other glucose oxidase.

The ingredients listed in Table 7 were mixed in a Hobart A-120 mixer using a McDuffy bowl and hook agitator for two minutes at speed one, thereafter for six minutes at speed two, to optimum gluten development, to a final dough temperature of 25° C. to 27° C. The fully mixed dough was allowed to rest, covered under plastic, for two minutes at room temperature.

TABLE 7

| Ingredients | amounts in grams |
|---|---|
| Wheat Bread Flour—USA | 1000 |
| Water | 660 |
| Yeast instant dry | 20 |
| Sugar | 40 |
| Shortening (soy bean oil) | 40 |
| Salt | 20 |

All ingredients were supplied by Inter-County Bakers, Inc. Lindenhurst, New York.

The dough was divided in pieces of 450 g, rounded and allowed to rest for two minutes at room temperature. Afterwards the dough pieces were moulded using a Unic moulder (top 6.5/bottom 6) and the moulded loaves were placed into bread pans and placed in a proofing cabinet at 38° C., at relative humidity of 85% for 85 minutes. Part of the fully proofed dough pieces were subjected to the stressful shock test as described in Materials & Methods. Then, dough pieces with and without shock test were placed in a BeCOM revolving oven and baked in 24 minutes at 205° C. Thereafter, the breads were taken out of the oven, de-panned and placed on a rack to cool for at least 1 hour at ambient temperature, which was typically between 20 and 25° C. After 1-2 hours cooling, the breads were assessed on weight and volume.

After cooling down to room temperature the weights of the loaves were determined using a Mettler Toledo scale with a precision of 0.01 gram. The volumes of the loaves were determined using a Loaf Volumeter (1 Pound Volumeter—National Cereal Chemistry Equipment). Results are shown in Table 8

TABLE 8

| | Relative | Relative |
|---|---|---|
| | Volume (%) | Volume (%) |
| | non shock | shock |
| Control | 100 | 100 |
| 10 ppm Bakezyme GO10.000 BG* | 106 | 119 |
| 10 ppm Penicillium glucose oxidase | 102 | 117 |
| 5 ppm Bakezyme GO10.000 BG and | 105 | 121 |
| 5 ppm Penicillium glucose oxidase | | |

*BakeZyme ® GO10.000 BG, (Aspergillus glucose oxidase as set out in SEQ ID No.3., from DSM Food Specialties, the Netherlands).

The non-shock test results show that the volume of the bread prepared using a combination of glucose oxidases (5 ppm each) showed a volume increase (5%).

The shock test results show that the combination of 5 ppm Aspergillus glucose oxidase and 5 ppm Penicillium glucose oxidase creates synergy in comparison to 10 ppm Aspergillus glucose oxidase or 10 ppm Penicillium glucose oxidase under stressful conditions such as in a shock test, creating improved stability, translated in increased volume of the final bread.

Crumb structure evaluation showed that bread containing Penicillium glucose oxidase resulted in bread with a finer crumb structure.

These results illustrate that a dough containing a combination of Penicillium glucose oxidase with another glucose oxidase results in a baked product with improved stability, translated in increased volume of the final bread and improved crumb structure.

1. A product comprising a composition comprising a combination of glucose oxidases for improving the stability of a dough, or the volume of a baked product or the crumb structure of a baked product.

2. Product according to claim 1, wherein the composition comprises a Penicillium glucose oxidase and a second glucose oxidase.

3. Product according to claim 2, wherein the second glucose oxidase is obtainable from a filamentous fungus.

4. Product according to claim 2, wherein the second glucose oxidase is obtainable from an Aspergillus.

5. Product according to claim 2, wherein the Penicillium glucose oxidase has an amino acid sequence having at least 75% identity to amino acids 19 to 604 of SEQ ID NO. 1.

6. A method for improving flour, which method comprises adding to the flour by weight of flour (i) 1 to 50 ppm of a Penicillium glucose oxidase and (ii) 1-200 ppm of a second glucose oxidase.

7. The method according to claim 6, wherein the second glucose oxidase is an Aspergillus glucose oxidase.

8. A pre-mix or flour comprising a Penicillium glucose oxidase and a second glucose oxidase.

9. A flour according to claim 8 comprising by weight of flour
a) 1 to 50 ppm of a Penicillium glucose oxidase; and
b) 1 to 200 ppm of a second glucose oxidase.

10. A pre-mix or flour according to claim 8, wherein the second glucose oxidase is an Aspergillus glucose oxidase.

11. A method for preparing a dough comprising combining a pre-mix or flour according to claim 8, with at least one dough ingredient.

12. A dough prepared from a pre-mix or flour according to claim 8.

13. A method for preparing a baked product comprising baking the dough according to claim 12.

14. A baked product prepared from a pre-mix or flour according to claim 8, or from a dough prepared from said pre-mix or flour.

15. A dough comprising a Penicillium glucose oxidase comprising an amino acid sequence as set out in amino acids 19 to 604 of SEQ ID NO. 1 and a second glucose oxidase, optionally wherein the second glucose oxidase is an Aspergillus glucose oxidase comprising an amino acid sequence having at least 85% identity to the amino acid sequence as set out in SEQ ID NO: 3.

16. A method for increasing dough stability comprising combining at least one dough ingredient, a Penicillium glucose oxidase comprising an amino acid sequence as set out in amino acids 19 to 604 of SEQ ID NO. 1 and a second glucose oxidase, optionally wherein the second glucose oxidase is an Aspergillus glucose oxidase comprising an amino acid sequence having at least 85% identity to the amino acid sequence as set out in SEQ ID NO: 3.
